(19) United States
(12) Patent Application Publication
(10) Pub. No.: US 2008/0022476 A1
(43) Pub. Date: Jan. 31, 2008

(54) Wiper Installation For The Windscreen Of A Motor Vehicle

(75) Inventors: Achim Kraus, Buehl (DE); Juergen Rapp, Lauf (DE); Guillaume Hirtz, Genas (FR); Nicolas Eschenbrenner, Lorry-Les-Metz (FR)

Correspondence Address: MICHAEL BEST & FRIEDRICH LLP, 100 E WISCONSIN AVENUE, Suite 3300, MILWAUKEE, WI, 53202, US

(73) Assignee: ROBERT BOSCH GMBH, Stuttgart (DE)

(21) Appl. No.: 11/547,893

(22) PCT Filed: Mar. 17, 2005
(86) PCT No.: PCT/EP05/51251

§ 371 Date: Jun. 26, 2007

(30) Foreign Application Priority Data
Apr. 8, 2004 (DE) 10 2004 017 382.6

(51) Int. Cl. B60S 1/04; F16B 2/18

(52) U.S. Cl. 15/250.32; 15/250.001

(57) ABSTRACT

A wiper installation (1) which is easy to install and can be fixed on the body without screws. For this purpose, a plate-shaped area (15, 16) having a through bore (17, 18) is provided on both on the wiper installation side and on the vehicle side. A clamp lock (20) is comprised of a tie bolt (21) that can be inserted through the bores (17, 18) and a tension lever (22) which is rotatably disposed on its head portion (26). The clamp lock (20) is made of plastic and manufactured in a multi-component injection molding process as a one-part piece with a tension lever (22) rotatably disposed on the tie bolt (21).

### PRIOR ART

The invention relates to a wiper installation for a windshield of a motor vehicle with a fastening device featuring several fastening points on the wiper installation side, each of which is designed to detachably cooperate with corresponding fastening points on the vehicle side, wherein at least one pair of fastening points cooperates without screws.

This type of fastening of a wiper installation on the body of a motor vehicle is already known from DE 198 33 404 A1. The fastening on a given pair of fastening points is realized in this case as a plug-in or locking connection without screws, in which a fastening element projecting from the supporting structure of the wiper installation is provided, which is embodied for insertion into a corresponding receptacle opening embodied on the vehicle side. The receptacle opening itself is arranged in a special holding part, e.g., a rubber bushing, which is fastened to the vehicle body.

Normally, the known fastening devices for wiper installations have at least three spaced-apart fastenings, which can be embodied in different ways. In practice, most of the time at least one fastening is always realized by a screw, wherein a damping element is used for vibrational isolation between the wiper installation and the motor vehicle, and said damping element must be inserted during assembly, before screwing, into the thread bore provided for this on the vehicle side. The amount of expense required by the motor vehicle manufacturer with respect to providing assembly time and an assembly tool is considered too high as a whole when fastening the wiper installation using screws and a damping element. On the other hand, the fastenings without screws known from DE 198 33 404 A1 are also not easy to install in all aspects because of their multi-part structure, wherein with their use as alternatives to screws there is also doubt about the mechanical reliability of the fastening, which can only be overcome by an additional axial securing of the plug pin in the receptacle opening that is present as a rubber bushing.

In other technical contexts, e.g., in the case of bicycles or ski bindings, quick fastening devices are known, which do not make use of the plug or locking principle, but are embodied as clamp locks. DE 29 43 919 A1 discloses an eccentric clamp lock comprised of a tie bolt with a thickened foot portion and an eccentric tension lever that is fastened swivelably on its head portion around a rotational axis, with which two stacked plate-shaped elements between the underside of the tension lever and the thickened foot portion can be clamped or clamped together. In this case, providing the foot portion with a longish form that extends transverse to the bolt longitudinal axis is also known. This makes it possible to push said foot portion from the tension lever side through matching through bores into the to-be-connected elements and then rotate it by 90° so that the clamp lock can also be introduced in these types of elements in which no access is possible from the rear side for passing the tie bolt through the through bores. The known clamp locks are typically comprised of at least two metal parts; DE 29 43 919 A1 also mentions the possibility of making the tie bolts and the tension lever of its eccentric clamp lock each a plastic transfer molding part.

The present invention is based on the objective of creating a wiper installation of the type disclosed at the outset, which has a simple structure, is reliable and can be fastened to the vehicle body with low assembly expense.

This objective is attained in accordance with the invention by the characterizing features of claim 1. Advantageous embodiments of the invention are yielded from the subordinate claims.

In the case of the wiper installation in accordance with the invention, for the at least one fastening without screws, a preferably plate-shaped area having a through bore is provided on each the wiper installation side and the vehicle side. These areas can be arranged parallel with approximately congruent through bores, through which a clamp lock can be inserted, which is comprised of a tie bolt that can be inserted through the through bores, which tie bolt has a widened foot portion, and a tension lever rotatably disposed on its head portion with a cam or eccentric section. The clamp lock is preferably made of plastic and manufactured in a multi-component injection molding process as a one-part piece with a tension lever rotatably disposed on the tie bolt.

The wiper installation in accordance with the invention can be mounted quickly and ergonomically on the vehicle body without tools. The fastening using a clamp lock is reliable and resistant to the vibrations that occur in normal vehicle operation in particular. The wiper installation side and vehicle side requirements can be implemented simply and cost-effectively, particularly as compared with a fastening using screws. In addition, the fastening in accordance with the invention secures the exactly prescribed position of the wiper installation on the vehicle, and the fastening is also detachable and does not take up a lot of space. What is crucial for simplicity with regard to structure and assembly is the cost-effective, one-piece realization of the plastic clamp lock, which is made possible by advanced special methods of injection molding technology that are available nowadays.

In the case of an advantageous development of the invention, the tension lever is embodied to be U-shaped, wherein the ends of the U-legs are each embodied as a cam or eccentric section. The head portion of the tie bolt is embodied in this case as an approximately cylindrical axis running transverse to the bolt longitudinal axis, which cylindrical axis is positioned between the cam or eccentric sections sprayed directly on the ends of the cylindrical axis so they are rotatably disposed. Alternatively, however, a “reverse” embodiment is also possible in which the head portion of the tie bolt is embodied to be U-shaped and sprayed on as one-piece to the cam or eccentric section of the tension level that is embodied to be axis-like and arranged between the ends of the U-legs.

Preferred is a development in which the through bores have a thickened dumbbell-shaped contour on the end areas, and in which the foot portion of the tie bolt has a cross section formed to match this contour. As a result, the fastening can be installed from the wiper installation side, wherein the special advantage connected with the special shape of the contour is that, despite relatively low material use, a large bearing surface is made available to the foot portion when tensioning the tension lever.

Especially preferred is a development in which a circumferential rubber element is placed in the contour of one of the through bores, and in which the rubber element is stretched in such a way around the edge of the affected through bore that it grips over an edge area of the affected plate-shaped area at least on that side, which faces the parallel, second place-shaped area. The rubber element required in most cases for vibrational isolation can therefore be placed, in particular, in the contour of the through bore of the plate-shaped area on the wiper installation side so that the assembly expense previously connected with a damping element is no longer incurred when assembling a wiper installation that has been prepared in this way.

In the case of a further development of the invention, the cam or eccentric section of the tension lever is supported during swiveling on the facing side of the plate-shaped area on the wiper installation side directly adjacent to the tension lever, and that the tension lever has a swivel section with locking means, which can engage in a locking element arranged on the plate-shaped area on the wiper installation side, if the swivel section has swiveled into a position that is approximately parallel to the area on the wiper installation side. This measure further reinforces the locking effect that already goes hand in hand with the swiveling of the cam or eccentric section.

Exemplary embodiments of the invention are explained in detail making reference to the enclosed drawings. The drawings show:

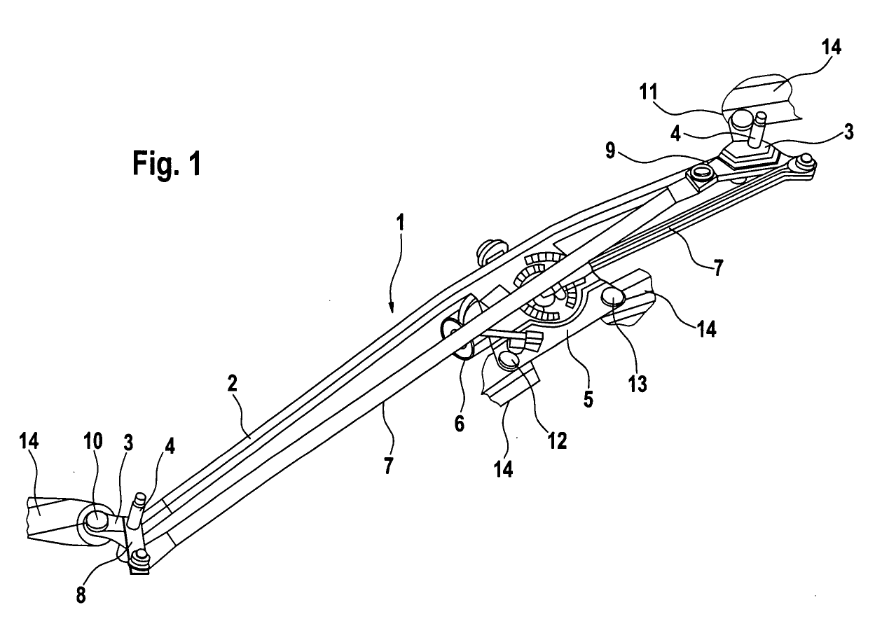

FIG. 1 A perspective representation of a windshield wiper installation with a fastening device without screws with a receptacle device on the vehicle side according to the prior art;

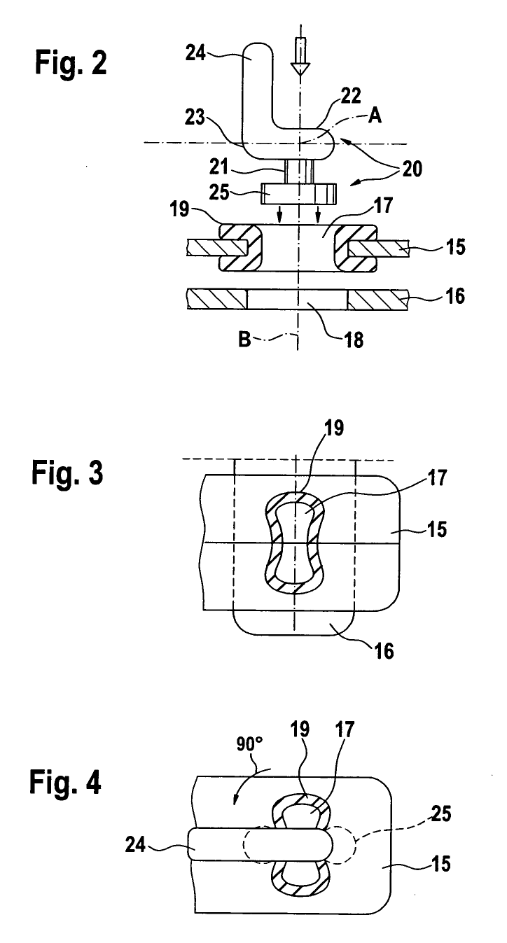

FIG. 2 A schematic lateral section through an individual fastening in accordance with the invention before assembly;

FIG. 3 A top view of the areas of the wiper installation and the vehicle body prepared for fastening in accordance with the invention, however without a clamp lock;

FIG. 4 A top view in accordance with FIG. 3, however, with a clamp lock that has been inserted, rotated and brought into the locked position;

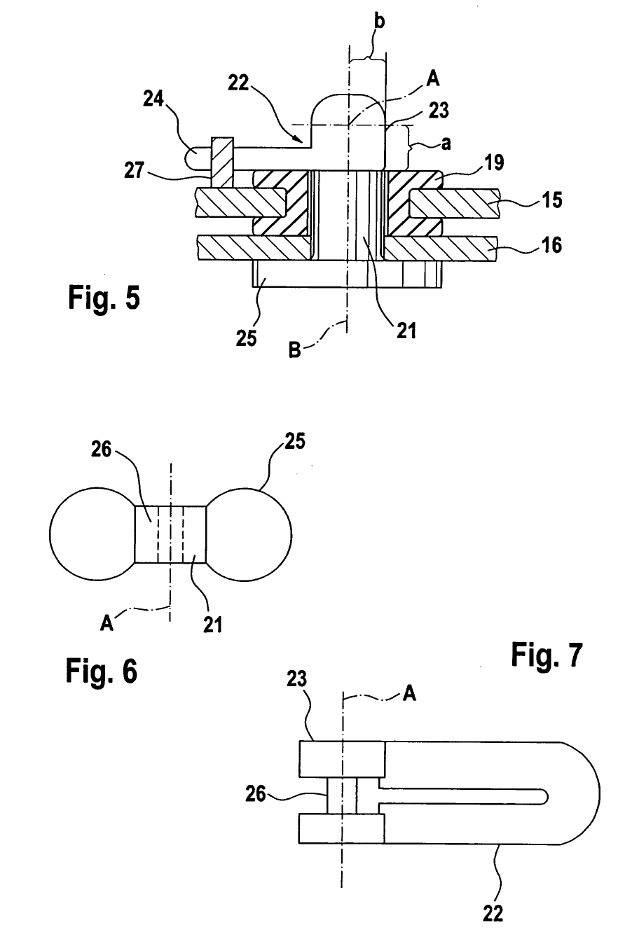

FIG. 5 A locked fastening in a state in accordance with FIG. 4 in the same representation as FIG. 1;

FIGS. 6 and 7 Schematic representations, both in top views, of the tie bolt by itself and the tie bolt inserted into the tension lever.

FIG. 1 shows a windshield wiper installation for a motor vehicle known from the prior art, which is comprised of a rod-like supporting body 2, which bears a bearing body 3 (molded tube) respectively on both ends. A wiper shaft 4 to accommodate a windshield wiper arm (not shown) is axially secured and rotatably disposed in each bearing body 3. Sitting approximately in the center of the supporting body 2 is the mounting plate 5 [and] a drive device 6, which operates on a connecting rod 7. The ends of the connecting rod 7 are connected in an articulated manner with the oscillating cranks 8 and 9, each of which are in turn rigidly connected to the wiper shafts 4.

The known windshield wiper installation 1 is fastened to a vehicle body 14 by means of a fastening device at points 10, 11, 12 and 13 beneath a windshield (not shown). Currently, the fastening is typically realized at least at one of the points 10 through 13 by means of a screw, while plug pins can be provided at the other points on the wiper installation side. In other embodiments, the windshield wiper installation 1 can also be equipped with two or more bearings 3 for a wiper shaft 4 or other mechanical modifications respectively.

FIG. 2 shows a plate-shaped area 15 of the wiper installation 1 with a through bore 17 and an area 16 of the vehicle body 14 arranged parallel to it with a bore 18 that is approximately congruent to bore 17. A rubber element 19 is placed, in particular inserted, in the contour of the bore 17 as damping, wherein the rubber element 19, as shown, grips around the edge of the area 15 so far on its underside that a surface that is adequate for damping between the adjacent areas 15 and 16 (which are pressed against one another in the subsequent fastening) is made available.

The clamp lock 20 made of plastic that is shown in FIG. 2 is comprised of a tie bolt 21 and a tension lever 22. The tension lever 22 has a cam or eccentric section 23, whose function will be explained in more detail below in connection with FIG. 5, as well as a swivel section 24. The tie bolt 21 has a widened foot portion 25, which typically has a longish shape and extends transverse to the bolt longitudinal axis B. The head portion, not shown here in FIG. 2, of the tie bolt 21 is rotatably disposed on the tension lever 22 so that the tension lever 22, in the embodiment and depiction provided here, can be swiveled counterclockwise around an axis A that runs perpendicular to the plane of the paper. As the arrows indicate, the entire clamp lock 20 is pushed from above through the stacked through bores 17 and 18. Deviating from the embodiment depicted in FIG. 1, the vertical arrangement of the areas 15 and 16 can be interchanged without hesitation. For reasons related to ease of assembly, it is preferred if the rubber element 19 is attached in the through bore 17 of the area 15 on the wiper installation side, which area can be formed on a molded tube (see bearing body 3 in FIG. 1), i.e., if necessary, together with area 15 interchange the position with area 16.

The top view in FIG. 3 depicts an embodiment of the invention with a special shape of the through bores 17 and 18 or of the foot portion 25. The longish shape of the bores 17 and 18 that is somewhat constricted in the middle makes possible a (corresponding adapted) foot portion 25 that fits through the bores, which, on the one hand, has a large bearing surface towards the underside of the area 16 according to FIG. 2, and, on the other hand, however, does not go hand in hand with an undesirably high use of material.

FIG. 4 depicts the state of the fastening after the clamp lock 20, more precisely the foot portion 25 and a portion of the center piece of the tie bolt 21, has been pushed through the matching passage openings 17 and 18, the foot portion 25 (together with the entire clamp lock 20) was then rotated in a position altered by 90°, for example, and finally, the tension lever 24 [sic] was swiveled from its position parallel to the bolt longitudinal axis B by approx. 90°, i.e., around its cam or eccentric section 23 supported on the plate-shaped area 15.

The lateral section in FIG. 5 again shows the locked position of the fastening that is achieved in accordance with FIG. 4. The widened foot portion 25 in this case grips behind the area 16 from the “rear” side while the clamp lock 20 is supported on the “front side” of area 15. The function of the cam or eccentric section 23 that is known per se is based on the fact that, because of the geometric design with the lengths a>b, the swiveling of the tension lever 22 goes hand in hand with a cam stroke, i.e., a displacement of the tie bolt 21, which is utilized to tension the lock 20. The plate-shaped areas 15 and 16 are consequently clamped or squeezed by swiveling the tension lever 22 into the clamping position between the underside of the tension lever 22 and the widened foot portion 25 as shown in FIG. 5.

As FIG. 5 shows, the locking effect brought about by the clamp lock 20 can be further reinforced by a locking nose 27 that projects from the upper side of the area 15 and engages in an appropriate locking receptacle in the swivel section 24.

FIGS. 6 and 7 schematically show a top view of an exemplary embodiment of the intermeshing of the clamp lock's 20 two components, i.e., of the tie bolt 21 and the tension lever 22. FIG. 6 depicts in particular the head portion 26 of the tie bolt 21, which can be embodied to be approximately cylindrical for example. FIG. 7 shows the position of the cylindrical head portion 26 as an axis between the ends of the U-legs, i.e., the cam or eccentric sections 23, of the tension lever 22 that is embodied to be U-shaped.

In the meantime injection tools for plastic components are known, which allow the components of the parts to be injected into one another. In the case of the process of multi-component injection molding that is known per se (also called two-shot or over-molding method), the preliminary injection molding is injected from the first component into a cavity of the mold. This is then supplemented by additional components in subsequent cavities by the releasing of volume, wherein the preliminary injection molding is also transported if necessary. It particular, it is also possible using a method that is sometimes called assembly injection molding to produce movable (vis-à-vis one another), non-detachable connections between two components of a part. In the case of the clamp locks being used for the wiper installation in accordance with the invention, which have a rotatably disposed, i.e., sprayed-on, tension lever 22 arranged on the tie bolt 21, the required full bonding incompatibility of the two components can be advantageously realized by using different plastics for the components and the correspondingly varying shrinkage behavior, or else by correspondingly adapting the injection parameters and injection molding cycle times in order to avoid “bonding” of the components. The advantage of this multi-component injection molding in the context related to the invention is that creating a one-part clamp lock with rotatable components, wherein the assembly process of the components that would otherwise be required is shifted to the injection mold. The use of the one-piece plastic clamp lock 20 in accordance with the invention makes a simply structured and easy-to-install wiper installation fastening possible.

1. Wiper installation (1) for a windshield of a motor vehicle with a fastening device featuring several fastening points on the wiper installation side, each of which is designed to detachably cooperate with corresponding fastening points on the vehicle side, wherein at least one pair of fastening points cooperates without screws, characterized in that for the at least one fastening without screws an area (15, 16) having a through bore (17, 18) is provided on each the wiper installation side and the vehicle side, and that a clamp lock (20) is provided, which is comprised of a tie bolt (21) that can be inserted through the through bores (17, 18), which tie bolt has a widened foot portion (25), and a tension lever (22) rotatably disposed on its head portion (26) with a cam or eccentric section (23).

2. Wiper installation according to claim 1, characterized in that the clamp lock (20) is made of plastic and manufactured in a multi-component injection molding process as a one-part piece with a tension lever (22) rotatably disposed on the tie bolt (21).

3. Wiper installation according to claim 1, characterized in that the tension lever (22) is embodied to be U-shaped, wherein the ends of the U-legs are each embodied as a cam or eccentric section (23), and that the head portion (26) of the tie bolt (21) is embodied as an approximately cylindrical axis running transverse to the bolt longitudinal axis (B), which cylindrical axis is positioned between the cam or eccentric sections (23) sprayed directly on the ends of the cylindrical axis so they are rotatably disposed.

4. Wiper installation according to claim 1, characterized in that the through bores (17, 18) have a thickened dumbbell-shaped contour on the end areas, and that the foot portion (25) of the tie bolt (21) has a cross section formed to match this contour.

5. Wiper installation according to claim 1, characterized in that a circumferential rubber element (19) is placed in the contour of one of the through bores (17, 18), and that the rubber element (19) is stretched in such a way around the edge of the affected through bore (17, 18), that it grips over an edge area of the affected plate-shaped area (15, 16) at least on that side, which faces the parallel, second place-shaped area (15, 16).

6. Wiper installation according to claim 5, characterized in that the rubber element (19) is placed in the contour of the through bore (17) of the plate-shaped area (15) on the wiper installation side.

7. Wiper installation according to claim 1, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.

8. Wiper installation according to claim 2, characterized in that the tension lever (22) is embodied to be U-shaped, wherein the ends of the U-legs are each embodied as a cam or eccentric section (23), and that the head portion (26) of the tie bolt (21) is embodied as an approximately cylindrical axis running transverse to the bolt longitudinal axis (B), which cylindrical axis is positioned between the cam or eccentric sections (23) sprayed directly on the ends of the cylindrical axis so they are rotatably disposed.

9. Wiper installation according to claim 2, characterized in that the through bores (17, 18) have a thickened dumbbell-shaped contour on the end areas, and that the foot portion (25) of the tie bolt (21) has a cross section formed to match this contour.

10. Wiper installation according to claim 3, characterized in that the through bores (17, 18) have a thickened dumbbell-shaped contour on the end areas, and that the foot portion (25) of the tie bolt (21) has a cross section formed to match this contour.

11. Wiper installation according to claim 2, characterized in that a circumferential rubber element (19) is placed in the contour of one of the through bores (17, 18), and that the rubber element (19) is stretched in such a way around the edge of the affected through bore (17, 18), that it grips over an edge area of the affected plate-shaped area (15, 16) at least on that side, which faces the parallel, second place-shaped area (15, 16).

12. Wiper installation according to claim 3, characterized in that a circumferential rubber element (19) is placed in the contour of one of the through bores (17, 18), and that the rubber element (19) is stretched in such a way around the edge of the affected through bore (17, 18), that it grips over an edge area of the affected plate-shaped area (15, 16) at least on that side, which faces the parallel, second place-shaped area (15, 16).

13. Wiper installation according to claim 4, characterized in that a circumferential rubber element (19) is placed in the contour of one of the through bores (17, 18), and that the rubber element (19) is stretched in such a way around the edge of the affected through bore (17, 18), that it grips over an edge area of the affected plate-shaped area (15, 16) at least on that side, which faces the parallel, second place-shaped area (15, 16).

14. Wiper installation according to claim 2, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.

15. Wiper installation according to claim 3, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.

16. Wiper installation according to claim 4, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.

17. Wiper installation according to claim 5, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.

18. Wiper installation according to claim 6, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.

19. Wiper installation according to claim 8, characterized in that the through bores (17, 18) have a thickened dumbbell-shaped contour on the end areas, and that the foot portion (25) of the tie bolt (21) has a cross section formed to match this contour.

20. Wiper installation according to claim 19, characterized in that a circumferential rubber element (19) is placed in the contour of one of the through bores (17, 18), and that the rubber element (19) is stretched in such a way around the edge of the affected through bore (17, 18), that it grips over an edge area of the affected plate-shaped area (15, 16) at least on that side, which faces the parallel, second place-shaped area (15, 16).

21. Wiper installation according to claim 20, characterized in that the rubber element (19) is placed in the contour of the through bore (17) of the plate-shaped area (15) on the wiper installation side.

22. Wiper installation according to claim 21, characterized in that the cam or eccentric section (23) of the tension lever (22) is supported during swiveling on the facing side of the plate-shaped area (15) on the wiper installation side directly adjacent to the tension lever (22), and that the tension lever (22) has a swivel section (24) with locking means, which can engage with a locking element (27) arranged on the plate-shaped area (15) on the wiper installation side, if the swivel section (24) has swiveled into a position that is approximately parallel to the area (15) on the wiper installation side.
